(19) United States
(12) Patent Application Publication
(10) Pub. No.: US 2011/0052069 A1
(43) Pub. Date: Mar. 3, 2011

(54) Image search apparatus

(75) Inventors: Sumie Nakabayashi, Tokyo (JP); Hideaki Uchikoshi, Tokyo (JP); Seiichi Hirai, Tokyo (JP); Takashi Mito, Tokyo (JP); Tsuneo Kawaba, Tokyo (JP)

(73) Assignee: Hitachi Kokusai Electric Inc., Tokyo (JP)

(21) Appl. No.: 12/805,925

(22) Filed: Aug. 25, 2010

(30) Foreign Application Priority Data
Aug. 27, 2009 (JP) 2009-197067

(51) Int. Cl. G06K 9/68; G06K 9/54

(52) U.S. Cl. 382/190; 382/305

(57) ABSTRACT

An image search apparatus includes: an image feature extraction unit for extracting features of images; an image search data storage unit for storing the features of the images; a user interface unit for inputting an image search condition, and displaying a search result; and an image search execution unit for executing an image search, by using the features of the images based on the image search condition, wherein the user interface unit allows multiple key images to be inputted as the single search condition, the image search execution unit executes the search by using key images included in the single search condition, and the user interface unit displays the search result in the order of similarities to the key images.

### FIELD OF THE INVENTION

The present invention relates to an image search apparatus for searching an image by using image features; and, more particularly, to an image search apparatus for searching and displaying an image, which matches search conditions, from images stored in an image pick-up apparatus such as a surveillance camera.

### BACKGROUND OF THE INVENTION

Recently, due to an increase in security awareness as well as needs to save in security manpower expenditure, a surveillance system using a camera (surveillance camera) for picking up a moving image or still image to be used in monitoring has drawn attention.

The surveillance system is a system which includes an image pick-up apparatus, such as a surveillance camera for crime prevention, and a display unit for displaying an image such as a still image or moving image acquired by the image pick-up apparatus.

In such a surveillance system, the image pick-up apparatus is typically installed at a place, where surveillance is needed for crime and/or disaster prevention, in a facility, such as hotels, buildings, convenience stores, financial agencies, dams or roads, where many unspecified persons visit. Further, the monitoring personnel residing in a management office observe and record picked-up images, and call attention when needed.

However, the surveillance system has been large-scaled and designed to cover a broad area in recent years. Thus, the number of surveillance cameras installed therein increases and, in a system that has the monitoring personnel who see and check images by eyes, the monitoring personnel's burden is also growing.

Moreover, a great deal of time is required to search a necessary image from a large amount of recorded images.

To address this, there has been developed an image recording technology that operates in conjunction with the detection of occurrence of such an event as a sensor alarm and to pick up an image only when necessary.

In addition, a search technology has been developed to search a recorded image by using the detection event itself as a search condition.

In a system that employs such image recording technology and/or search technology, detection events need to be set in advance.

Thus, when a detection event which is not preset occurs, there may be a case where even recording itself is not made or there is inconvenience to have recorded images to be checked by eyes even when recording of such event has been made.

To this end, there has been proposed a search method which searches an image similar to a key image from recorded images by using the key image even if the detection event is not preset.

This type of search method calculates a similarity between an image feature of the key image and an image feature of each of the recorded images and outputs a recorded image with the highest similarity as a search result.

Japanese Patent Application Publication No. 2005-352780 discloses a conventional image recording apparatuses, which searches a similar image to a key image, and a control method thereof. The image recording apparatus, which has a storage medium for storing multiple image data to be searched, searches and detects image data similar to key image data from such multiple image data, and displays extracted similar image data and the key image data in a form that visually distinguishes them from each other.

In the above-described patent document, however, different search results may be obtained depending on direction of face in a key image.

That is, for a key image corresponding to a full (front) face, there has been a tendency that a full face of a person is outputted at a high rank in the search results, and, an oblique face of the same person is outputted at a low rank in the search results. On the contrary, when an oblique face is used as a key image, an oblique face tends to occupy a high rank in the search results.

In other words, since an image to be located at a high rank in search results varies depending on a selection of the key image, there frequently have occurred cases in which the similar image to the key image was not able to be searched. Thus, multiple searches need to be conducted by using key images with different pick-up angles, resulting in poor search efficiency.

### SUMMARY OF THE INVENTION

In view of the above, the present invention provides an image search apparatus to solve the above-described problems of the prior art.

In accordance with an embodiment of the present invention, there is provided an image search apparatus, including: an image feature extraction unit for extracting features of images; an image search data storage unit for storing the features of the images; a user interface unit for inputting an image search condition, and displaying a search result; and an image search execution unit for executing an image search, by using the features of the images based on the image search condition, wherein the user interface unit allows multiple key images to be inputted as the single search condition, the image search execution unit executes the search by using key images included in the single search condition, and the user interface unit displays the search result in the order of similarities to the key images.

### BRIEF DESCRIPTION OF THE DRAWINGS

The objects and features of the present invention will become apparent from the following description of embodiments, given in conjunction with the accompanying drawings, in which:

FIG. 1 is a block diagram of a surveillance system X that executes a similar face image search method in accordance with an embodiment of the present invention;

FIG. 2 is a flowchart of a specific target search process in accordance with the embodiment of the present invention;

FIGS. 3A to 3C are conceptual views showing data in an image search data storage unit shown in FIG. 1 in accordance with the embodiment of the present invention;

FIG. 4 is an example of screens of a user interface unit shown in FIG. 1 in accordance with the embodiment of the present invention;

FIG. 5 is a flowchart of a key image updating process using the preregistered key images with similarity not less than the threshold value in accordance with the embodiment of the present invention;

FIG. 6 is a flowchart of a key image updating process using a preregistered key image with the highest similarity in accordance with the embodiment of the present invention;

FIGS. 7A to 7C are examples of a key image display area used in the key image updating process using the preregistered key images with similarity not less than the threshold value in accordance with the embodiment of the present invention;

FIG. 8 is an example of a key image display area used in the key image updating process using a preregistered key image with the highest similarity in accordance with the embodiment of the present invention;

FIG. 9 shows a display setup area for setting a display mode of the key image display area in accordance with the embodiment of the present invention. FIGS. 10A and 10B are examples of a search result display area in accordance with the embodiment of the present invention; and

FIG. 11 is a diagram showing a sequence of an automatic search process in accordance with the embodiment of the present invention.

### DETAILED DESCRIPTION OF THE EMBODIMENTS

[Control Configuration of Surveillance System X]

Hereinafter, embodiments of the present invention will be described with reference to the accompanying drawings which form a part hereof.

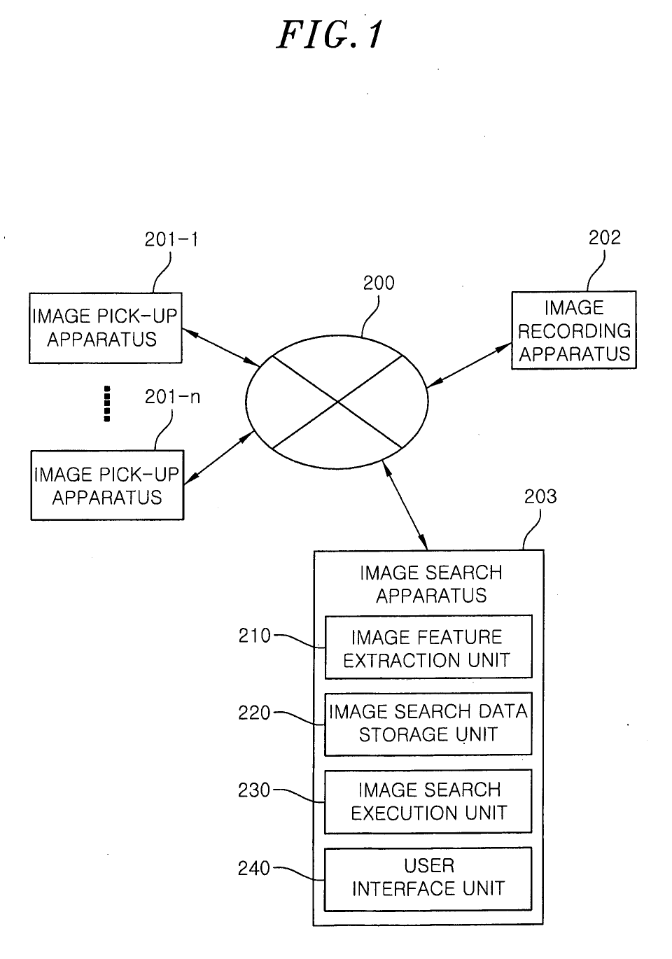

FIG. 1 shows a configuration of a surveillance system X.

Referring to FIG. 1, the surveillance system X includes image pick-up apparatuses 201-1 to 201-n, an image recording apparatus 202, and an image search apparatus 203, which are connected via a network 200.

The network 200 is a circuit line, available for data communications, such as LAN, optical fiber, c. link, wireless LAN, mesh network or the like, to connect the respective apparatuses. Also, a dedicated line, IP network such as intranet and Internet, or the like may be used as the network 200.

The image pick-up apparatuses 201-1 to 201-n are image pick-up apparatuses, such as Internet protocol (IP) cameras or network cameras, which are connected to the network 200 to pick up and transmit image data by using a charge coupled device (CCD) or a complementary metal oxide semiconductor (CMOS) image sensor. Each of the image pick-up apparatuses 201-1 to 201-n also include, e.g., a human detection sensor, a motion sensor and/or a microphone for detecting the detection events described above. Further, the image pick-up apparatuses 201-1 to 201-n may be conventional television cameras configured such that they are connected directly to the image recording apparatus 202 and a conversion operation into image digital data may be carried out by using an image/voice encoder (not shown) of the image recording apparatus 202.

The image recording apparatus 202 is an apparatus, such as a network digital recorder, which records images from the image pick-up apparatuses 201-1 to 201-n via the network 200. The image recording apparatus 202 includes a control and operation unit such as CPU, and a storage unit such as a built-in DRAM or flash memory.

Further, the image recording apparatus 202 records the image data inputted from the image pick-up apparatuses 201-1 to 201-n via the network 200 in a recording medium such as HDD.

In the surveillance system X, when reading out images from the image recording apparatus 202, a corresponding image can be read out from the image recording apparatus 202 by designating a camera identification (ID) and time information.

The image search apparatus 203 is a dedicated monitoring terminal apparatus, e.g., a PC (personal computer), such as a PC/AT (personal computer/advanced technology) compatible machine or MAC, which displays the image data acquired from the image recording apparatus 202 via the network 200 on a display monitor such as a liquid crystal monitor or CRT, and executes image searching.

The image search apparatus 203 includes a control unit which includes, e.g., central processing unit (CPU), microprocessor unit (MPU), digital signal processor (DSP), graphic processing unit (GPU), or a processor only for image searching, to execute a control of processes to be discussed below. The image search apparatus 203 further includes a storage unit, such as RAM, ROM, HDD, flash memory or the like, which stores a program executing the processes such as image search, image data for displaying search results, attributes and date and time data of the image data. The image search apparatus 203 also includes a user input unit such as a keyboard, a mouse and the like, and provides a user interface which executes a reproduction operation of the image stored in the image recording apparatus 202 and a display of the moving image, an execution operation of image search for a person and a display of search results, and the like.

In addition, the image search apparatus 203 includes an image feature extraction unit (feature extraction means) 210, an image search data storage unit (feature storage means) 220, an image search execution unit (image search means) 230, and a user interface unit (user interface means) 240.

The image feature extraction unit 210 includes, e.g., a control unit, a DSP, a program for the DSP, and a program for the control unit, which are used for extracting an image feature. The image feature extraction unit 210 executes, by using an image recognition technique, a person detection, an object detection, and an image feature extraction with respect to the image data stored in the image recording apparatus 202. Further, the image feature extraction unit 210 outputs thus-extracted image feature as image feature data.

First, for the person detection, the image feature extraction unit 210 determines whether or not a face exists in the image by using a known face detection technique and, upon detecting the presence of the face, calculates a coordinate of its region.

Similarly, for the object detection, the image feature extraction unit 210 determines whether or not there is an ‘object’ that represents an image region of a specific thing or clothes, and calculates its coordinate. For the coordinate calculation of the clothes region, the image feature extraction unit 210 may use a conventional technique which, e.g., extracts a contour of a person by using a dynamic program and detects clothes using color distribution or frequency characteristics (frequency distribution upon execution of a fast Fourier transform (FFT) or wavelet transform, and the like.) of texture within the contour.

The image feature extraction unit 210 calculates a face feature, an object feature, and the like, as the image feature. For detection of the face feature, the image feature extraction unit 210 detects vector components and/or statistics that are statistically different for each individual depending on a contour of image, a shape or direction of face contour, a color of skin, and/or a size, shape and layout of main body parts such as eyes, nose, and mouth. Further, for detection of the object feature by using the image recognition technique, the image feature extraction unit 210 detects, for example, a clothes feature. For detection of the clothes feature, the image feature extraction unit 210 detects and use, e.g., the color distribution or frequency characteristics of clothes stated above as the clothes feature, with respect to the clothes region.

The image search data storage unit 220 is a part that stores the image feature, image data (frame), and/or search result images associated with the image search. Specifically, the image search data storage unit 220 includes a control unit, a storage unit, and a program executed in the control unit for reading out and writing from/to the storage unit the image feature data detected by the image feature extraction unit 210. The storage unit of the image search data storage unit 220 includes a main memory device such as RAM, and an auxiliary memory device such as HDD and/or flash memory.

The image feature data may be stored in the image recording apparatus 202 via a network transceiver (not shown) such as a LAN card.

In addition, the image feature extraction unit 210 directly stores various data in the image search data storage unit 220 by direct memory access (DMA) and the like.

The image search execution unit 230 is a part that uses the image search data storage unit 220 based on input search condition, and executes the search process of the image recording apparatus 202 that records images picked up by the image pick-up apparatuses 201-1 to 201-n such as a surveillance camera.

Specifically, the image search execution unit 230 reads out image features from the image search data storage unit 220 upon receipt of a search condition from the user interface unit 240, and calculates similarities between the read image features and image features of key images included in the search condition, by using the program executed in its control unit.

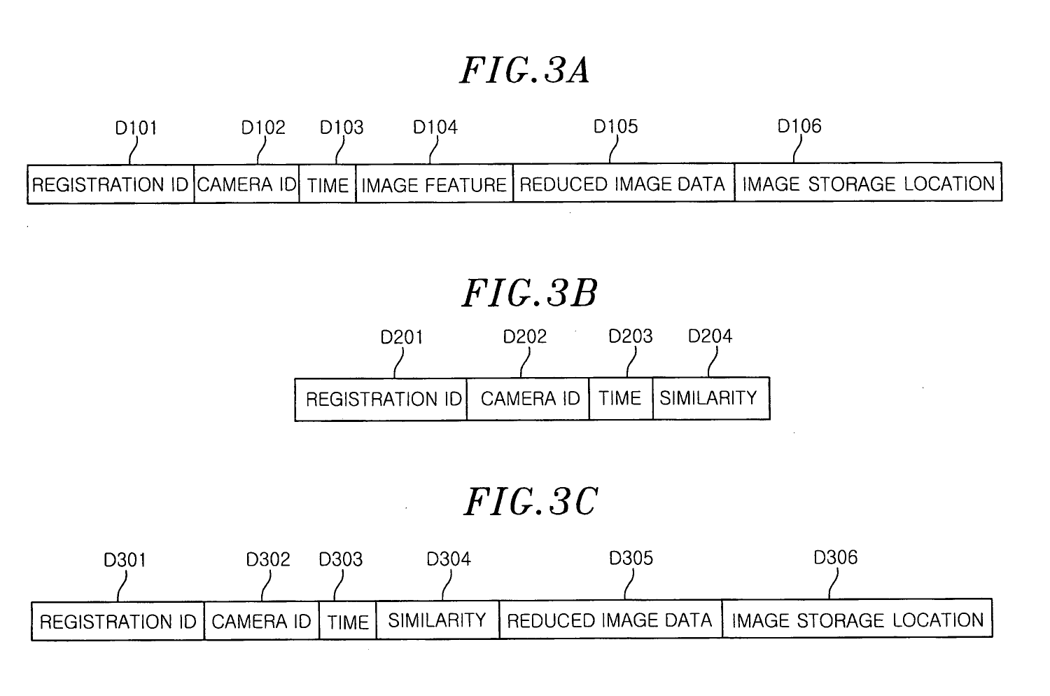

At this time, for read image features with a similarity above a threshold value to the key image features, the image search execution unit 230 conserves data corresponding to the read image features (see FIGS. 3B and 3C).

Upon completion of the above process on the image feature within a search range, the image search execution unit 230 transmits all or a part of the conserved image data as the search result to the user interface unit 240.

In addition, the image feature of the key image may be calculated at the image search execution unit 230. On the other hand, if the image feature of the key image is stored in the image search data storage unit 220, the stored image feature of the key image may be used.

The user interface unit 240 is a part that inputs the search condition and displays the search result. Specifically, the user interface unit 240 executes the search condition and displays the search result on the display unit (not shown) such as a liquid crystal monitor, by using a program executed in a user control unit. Also, the user interface unit 240 detects, as an input instruction, an input by a user through an input unit (not shown) having a pointing device such as a mouse, a keyboard or a jog shuttle, and the like. Here, an application programming interface (API) of operating system (OS) is used for the detection of the input instruction. Further, the user interface unit 240 displays such detection results on the display unit (not shown) such as a liquid crystal monitor, a plasma display, or the like.

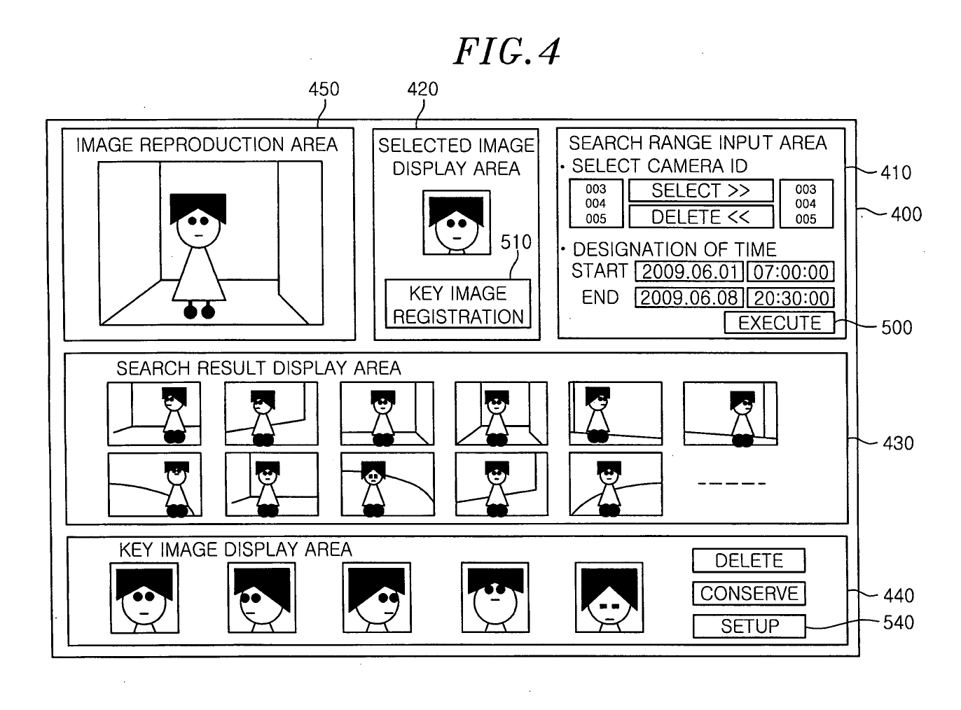

Further, upon request for reproduction of an image, the user interface unit 240 requests the image recording apparatus 202 to send a corresponding image. The user interface unit 240 displays, upon receipt of a response image from the image recording apparatus 202, the response image on an image reproduction area 450 (see FIG. 4). In this manner, the user interface unit 240 reproduces and displays the image on the image reproduction area 450 by continuously repeating the process that reads out the image from the image recording apparatus 202 and displays it.

Additionally, the user interface unit 240 can stop the reproduction of an image being displayed on the image reproduction area 450 to display the image on the selected image display area 420 (see FIG. 4). The images stored in the image recording apparatus 202 include images obtained by picking up a specific target at several angles.

The user interface unit 240 can register, as the key images, the images and/or partial images of coordinate region of an object or a face that can be obtained by executing an object detection or face detection from the images.

Furthermore, the image search apparatus 203 may be realized by the program stored in the storage unit of PC in which the conventional OS is installed.

In addition, the image feature extraction unit 210, the image search data storage unit 220, and the image search execution unit 230 as programs executed by using the hardware resources in the control unit may be embedded in the storage unit of the image search apparatus 203 or in a read-only memory (ROM) or flash memory within the control unit.

Now, an image search process using the surveillance system X in accordance with the embodiment of the present invention will be described in more detail.

The image search process of this embodiment includes a specific target search process for executing multiple searches in accordance with an initiation instruction through the manipulation of the user; and an automatic search process for executing an automatic search based on the search condition and search time set by the user.

<Specific Target Search Process>

First, the specific target search process will be described in more detail.

As described above, in the image search using the image feature aiming at a person search, when a full face image of a person is used as a key image, full face images mostly tend to occupy a high rank in a search result. And, oblique faces of the same person tend to be located at a low rank in the search result. On the contrary, when an oblique face is used as a key image, oblique faces tend to occupy a high rank in the search result.

That is, since the image included in the high rank in the search results varies depending on the selection of the key image, many images having a person to be searched can be obtained by performing multiple searches using the key images with different pick-up angles. In this case, a wide image feature space serving as the feature search range can be efficiently searched by repeatedly performing searches by using, as a new key image, an additional image that is regarded with naked eyes as having low similarity with the previously used key image.

In this way, the search method that a user executes multiple searches while changing the key image is preferable in case of performing the image search regarding a specific target after occurrence of an event. In this embodiment, a user interface capable of simply executing such multiple searches is provided.

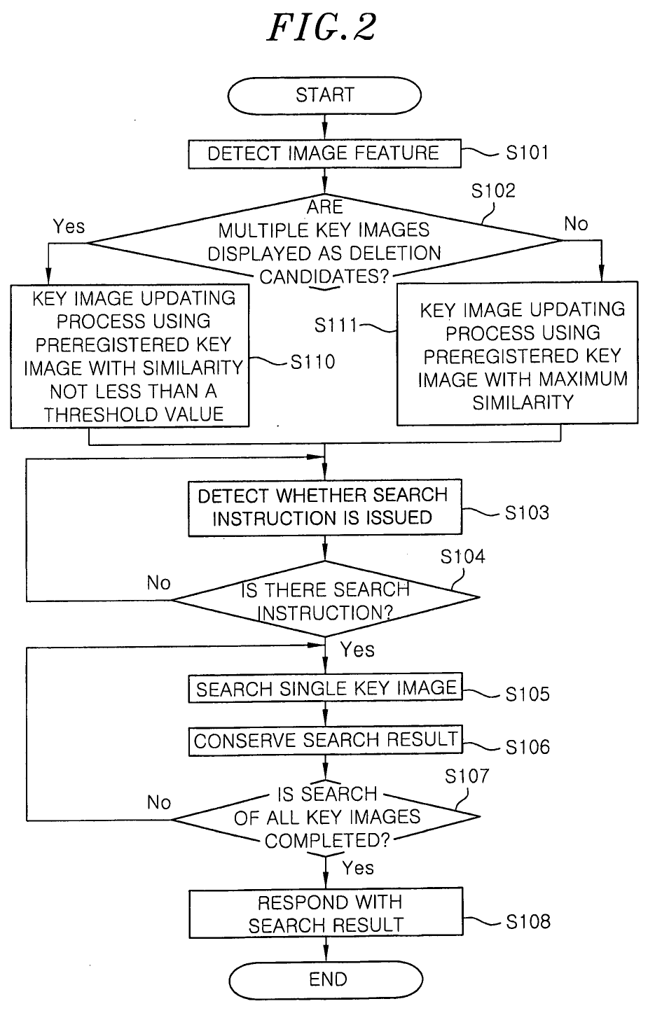

Hereinafter, the specific target search process related to the search method that executes multiple searches using the surveillance system X will be described in more detail with reference to a flowchart in FIG. 2. FIG. 2 shows a flow of the specific target search process in the image search execution unit 230 in case of using multiple images as the search condition.

First, at step S101, the image feature extraction unit 210 executes an image feature detection process.

Specifically, the image feature extraction unit 210 selects one image frame from a series of consecutive image frames obtained by the image pick-up apparatuses 201-1 to 201-n such as the surveillance camera, and extracts an image feature of the selected image frame. At this time, the image frame, from which the image feature extraction unit 210 detects the image feature, may be supplied from the image recording apparatus 202 or from the image pick-up apparatuses 201-1 to 201-n.

The selection of the image frame by the image feature extraction unit 210 may be made by various methods, e.g., at regular intervals, when variation occurs in the image, or in synchronism with notification from the outside, e.g., a sensor alarm.

In the method that selects the image frame upon occurrence of variations in the image, variations in color, shape, and the like are detected for each of the consecutive image frames. Also, the image feature extraction unit 210 separates the consecutive image frames in groups based on such variations and selects a representative frame from each group. The image features detected from these image frames are applied to the detection of the person or object described above, and may use multi-dimensional vectors representing the features of image such as color, shape, and the like. That is, the feature of a partial region of the image frame, such as the face region or object region obtained by the face detection or object detection, may be used depending on system purposes, without limiting to the feature of the whole image frame.

The image feature extraction unit 210 conserves the extracted feature in the image search data storage unit 220.

<Data Structure Used in Image Search Process>

With reference to FIGS. 3A to 3C, an example of the data structure used in both the specific target search process and the automatic search process will now be described.

FIG. 3A shows an example of the data structure of the image feature used in the image search data storage unit 220. The data of the image feature used in the image search data storage unit 220 includes a registration ID D101, a camera ID D102, a time D103, an image feature D104, reduced image data D105, an image storage location D106, and the like.

The registration ID D101 is an ID for identifying data of the image feature.

The camera ID D102 is an ID for identifying the image pick-up apparatuses 201-1 to 201-n that picks up an image.

The time D103 is data which expresses the time when the image frame is picked up or recorded in Greenwich Mean Time (GMT) or in terms of frame number.

The image feature D104 stores the image feature data extracted from the image frame by the image feature extraction unit 210.

The reduced image data D105 is data that stores reduced image data of the image frame. This reduced image data can be generated from an original image frame by the image feature extraction unit 210.

The image storage location D106 stores an address of the storage unit of the image recording apparatus 202 and/or an IP address of the image recording apparatus 202 by identifying the location (address) of the image recording apparatus 202.

FIGS. 3B and 3C show an example of the data structure of the search results stored in the image search data storage unit 220 by using the image search execution unit 230. The data in FIG. 3C can be obtained by reading out the data of the image feature from the image search data storage unit 220 by using the data in FIG. 3B.

The data of the search results in FIG. 3B includes a registration ID D201, a camera ID D202, a time D203, and a similarity D204. The registration ID 201, the camera ID D202, and the time D203 can use the same data as the registration ID 101, the camera ID D102, and the time D103, respectively. The similarity D204 can use the same value as the similarity of the image feature D104.

The data of the search results in FIG. 3C includes a registration ID D301, a camera ID D302, a time D303, a similarity D304, reduced image data D305, an image storage location D306. The registration ID 301, the camera ID D302, the time D303, the similarity D304, the reduced image data D305, and the image storage location D306 can use the same data as the registration ID 101, the camera ID D102, the time D103, the similarity D204, the reduced image data D105, and the image storage location D106, respectively.

<Screen Display Example of the User Interface Unit 240>

Next, an example of a screen display for use in detecting the manipulation by the user through the user interface unit 240 will be described with reference to FIG. 4.

A screen 400 in FIG. 4 shows an example of a display screen displayed on the display unit by the user interface unit 240. The screen 400 includes display regions such as a search range input area 410, a selected image display area 420, a search result display area 430, a key image display area 440, an image reproduction area 450.

The search range input area 410 is a display region for inputting the search time range and the camera ID which identifies the image pick-up apparatuses 201-1 to 201-n executing the image search. For the camera ID, multiple camera IDs may be designated. When a push on an ‘execute’ button 500 on the search range input area 410 is detected, the user interface unit 240 determines that the search instruction has been issued. Further, the data structure, such as the camera ID and the search time range, will be described in detail later.

The selected image display area 420 is a display region for displaying a selected image upon detection of the user's instruction through the input unit. The user interface unit 240 detects a push of a ‘key image registration’ button 510 on the selected image display area 420, and displays, on the selected image display area 420, an image being displayed on the image reproduction area 450 at the moment when the push of the ‘key image registration’ button 510 is detected. Further, the user interface unit 240 newly adds the displayed image on the selected image display area 420 as the key image for the image search. As the key image, image files and/or files such as images on the web pages as well as images stored in the image recording apparatus 202 may be referred and used.

The search result display area 430 is a display region for displaying images of the search results and/or additional information.

The key image display area 440 is a display region for displaying the key images which are referred to as the search conditions. The key image display area 440 generally displays registered key images thereon. On this display region, the deletion candidate images of the registered key images, similar to the newly added key image by the ‘key image registration’ button 510 described above, are presented and deleted by the user, and an appropriate key image is selected. This can prevent the number of key images from being increased and the search efficiency from being deteriorated. In this regard, the user can set a display mode of the key image display area 440 by pushing a ‘setup’ button 540 on the key image display area 440.

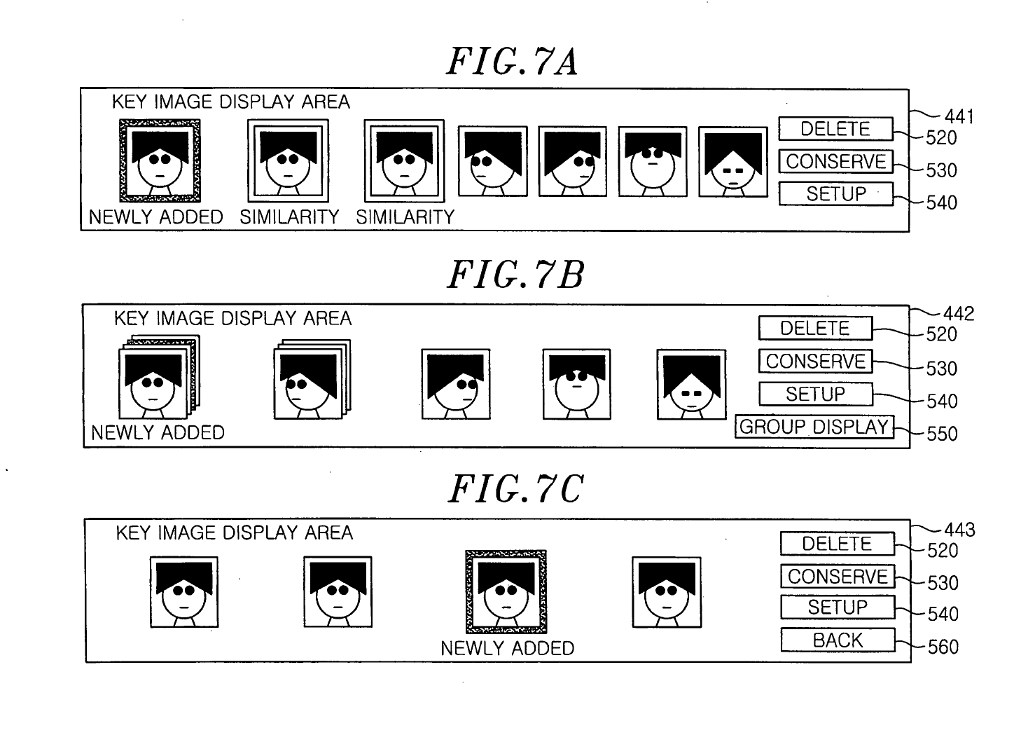

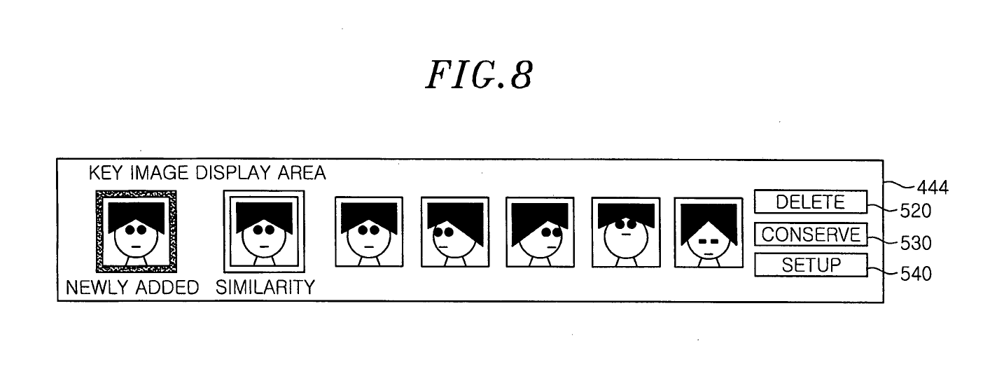

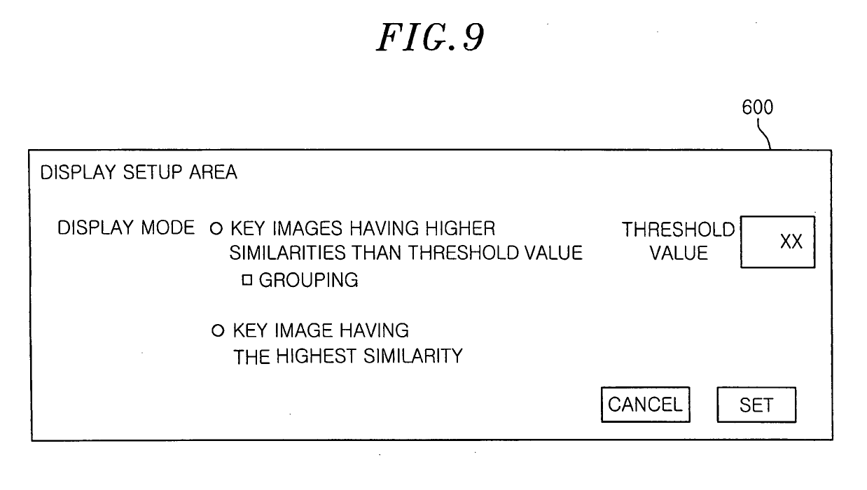

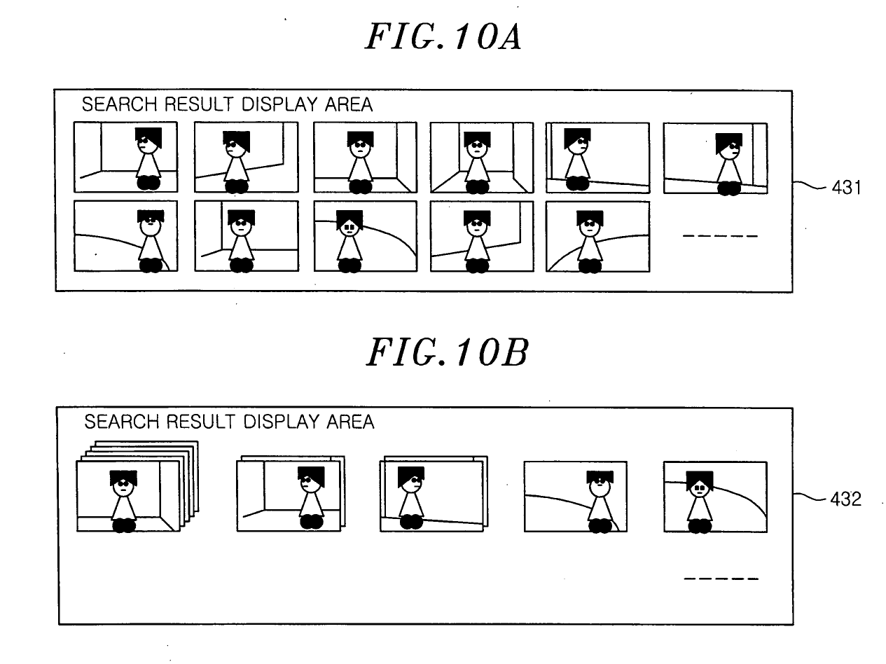

When the ‘setup’ button 540 is pushed, the display area is switched from the key image display area 440 to a display setup area 600 shown in FIG. 9. In the display setup area 600, the user can determine whether to identify and display multiple key images having higher similarities to the newly added key image than a threshold value or only a key image having the highest similarity to the newly added key image. This is done by selecting a display mode and pushing ‘set’ button. Then, the display setup area 600 is turned into a screen which corresponds to the user's setup. Examples of the displays depending on the user's setup are shown in FIGS. 7A, 7B and 8, which will be described later. When the user selects a ‘cancel’ button on the display setup area 600, a setup by user is not applied and return to the key image display area 440. In the display setup area 600, the threshold value is also displayed.

The image reproduction area 450 is a display region for continuously reproducing and displaying the images read out from the image recording apparatus 202.

Referring again to FIG. 2, the description of the specific target search process will now be continued.

At step S102, the image search execution unit 230 determines whether or not to adopt multiple key images as deletion candidates in execution of the registration of the key image. In this key image registration process, it is determined as Yes by the image search execution unit 230, if preregistered key images having higher similarities to the newly added key image than the threshold value are to be identified and displayed in plural as deletion candidate images by a setting of the display mode by the user.

In addition, it is determined as No by the image search execution unit 230, if a key image having the highest similarity to the newly added key image is to be identified and displayed as a deletion candidate image. In this case, the number of the candidate image to be displayed becomes only one.

In case of Yes, the process goes to step S110.

In case of No, the process goes to step S111.

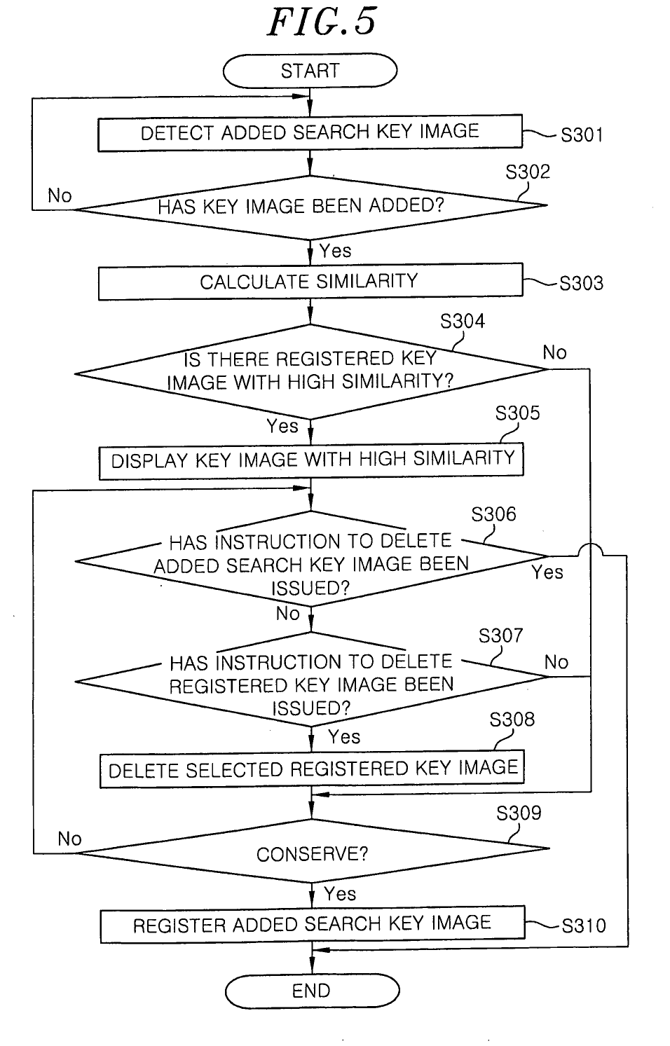

At step S110, the image search execution unit 230 executes a key image updating process using the preregistered key images with similarity not less than the threshold value to the newly added key image. This will be described in more detail with reference to a flowchart shown in FIG. 5.

As described above, the preregistered key images having higher similarities to the newly added key image than the threshold value are displayed as the deletion candidate images on the key image display area 440.

In this process, since the deletion candidate images are displayed depending on the threshold value, multiple candidate images or no candidate images can be displayed.

First, at step S301, the image search execution unit 230 detects an added search key image.

Specifically, the image search execution unit 230, upon detection of push on the ‘key image registration’ button 510 shown in FIG. 4 through the user interface unit 240, detects that the user has issued an instruction for adding a search key image. In this case, the image search execution unit 230 stores an image being referred and displayed on the selected image display area 420 as an added search key image in the image search data storage unit 220.

In other cases, it is detected that there is no instruction to add a search key image.

At step S302, the image search execution unit 230 determines whether or not the user has instructed to add a search key image.

In case of Yes, the process goes to step S303.

In case of No, the process returns to step S301 to wait for a user's instruction for adding a search key image.

At step S303, the image search execution unit 230 performs a similarity calculation process.

In this process, the image search execution unit 230 calculates similarities between the added search key image and the registered key images. Specifically, the image search execution unit 230 calculates distances between image features of the registered key images previously set by the user and an image feature of the added search key image to obtain similarities of the images.

Here, the distances between the added search key image and all the previously registered key images are calculated by using the image features extracted at step S101. Specifically, the distance Zᵢ between an image feature of the previously registered key image of a frame having a registration ID of i and an image feature of the added search key image may be defined as:

$${Z}_{i} = {\sum }_{j = 1}^{n} {w}_{j} \vert {x}_{ij} - {y}_{j} \vert , \qquad Equation 1$$

where an image feature Xᵢ of a key image having a registration ID of i is (xᵢ₁,xᵢ₂, . . . , xᵢₙ); an image feature Y of an added search key image the user intends to add is (y₁,y₂, . . . , yₙ); and a weight factor W showing an importance for each element of the image features is (w₁,w₂, . . . , wₙ).

It can be seen that, the smaller the distance value between the features is, the more the two images resemble to each other. Thus, the smaller Zᵢ is, the greater the similarity between the registered key image of a frame having a registration ID of i and the added search key image is.

At step S304, the image search execution unit 230 determines whether or not there is a registered key image with high similarity. That is, if there is a key image having the distance Zᵢ smaller than the threshold value set by the user, it is determined as Yes, and, if otherwise, it is determined as No.

In case of Yes, the process proceeds to step S305.

In case of No, the process proceeds to step S309.

At step S305, the image search execution unit 230 performs a process of displaying a registered key image with high similarity. In this process, the image search execution unit 230 allows the user interface unit 240 to display the registered key image with high similarity.

Describing in detail this with reference to FIGS. 7A to 7C, the user interface unit 240 identifies and displays the added search key image and the registered key images having high similarities to the newly added key image in response to an instruction of the image search execution unit 230.

More specifically, a key image display area 441 of FIG. 7A shows an example in which multiple deletion candidate images are displayed in response to the key image updating process using the preregistered key images with similarity not less than the threshold value of the flowchart of FIG. 5. The key image display area 441 of FIG. 7A is shown by selecting ‘key images having higher similarities than threshold value’ in the display setup area 600 shown in FIG. 9.

In the example of the key image display area 441 of FIG. 7A, the user interface unit 240 identifies and displays the newly added key image and the key images with high similarities, enclosing each of them by, e.g., color frame. By displaying so, the newly added key image and the key images with high similarities can be easily recognized by the user, and it is possible to improve a convenience in deleting or selecting a large amount of key images.

Further, on this key image display area 441, the user can issue an instruction to delete the newly added search key image or the registered key image by selecting each key image and pushing a ‘delete’ button 520 by using a keyboard or a pointing device.

In addition, the user can issue an instruction to conserve a new search key image being displayed on the key image display area 441 in the image search data storage unit 220, by pushing a ‘conserve’ button 530. When an instruction to conserve a new search key image is issued, the image search execution unit 230 stores the new search key image as a registered key image in the image search data storage unit 220.

These instructions are detected by the user interface unit 240.

Also, the key image display area 442 of FIG. 7B shows an example of classifying and displaying key images similar to each other into a group. The key image display area 442 is shown by pushing the ‘setup’ button 540 and selecting a ‘grouping’ in the display setup area 600 shown in FIG. 9. The user interface unit 240 detects the selection/unselection of the ‘grouping’ in the display setup area 600, and can switch the display areas, such as the key image display area 441 and the key image display area 442, to each other.

In this example, the user interface unit 240 displays, on the key image display area 442, image groups, i.e., an image group of the newly added key images and an image group of the registered key images that are similar to each other within the groups. Also, the user interface unit 240 displays, on the front side, a registered key image that is representative among the image group of the registered key images, and displays, on the rear side, images included in the image group of the registered key images in order of a magnitude of similarity with the representative image.

When the user selects an image group desired to be displayed and pushes a ‘group display’ button 550 on the key image display area 442 by using the pointing device or the like, the user interface unit 240 switches the display area to the key image display area 443 of FIG. 7C and displays the selected image group.

Further, on the key image display area 442, a user can also issue an instruction to delete or conserve the newly added key image by using the ‘delete’ button 520 or the ‘conserve’ button 530.

In addition, on the key image display area 442, the representative registered key image of the group can be displayed on the front side, and the newly added key images can be sequentially displayed depending on similarities to the representative registered key image. Further, the user interface unit 240 can also detect a manipulation through the pointing device or keyboard, and may change the sequence of the images displayed on the front side and the rear side.

Furthermore, as the method of classifying the images into a group of similar key images, an unweighted pair group method with arithmetic mean (UPGMA) method or a method of executing clustering such as a k-means method may be used.

The key image display area 443 of FIG. 7C shows an example that displays the images included in the group. As described above, by selecting a group desired to be displayed and pushing the ‘group display’ button on the key image display area 442, the user interface unit 240 displays the images included in the selected group.

When a ‘back’ button 560 is pushed on the key image display area 443, the display area returns to the key image display area 442.

On the key image display area 443, a user can also issue an instruction to delete or conserve the newly added key image and to delete a previously registered key image by pushing the ‘delete’ button 520 or the ‘conserve’ button 530. Thus, an instruction to select and register a specific key image within a group can be issued.

Referring again to FIG. 5, the description will be continued.

At step S306, the image search execution unit 230 determines whether or not the user has instructed to delete the added search key image. Specifically, the image search execution unit 230 determines whether or not there are a selection of the added search key image and a push on the ‘delete’ button 520 on the key image display area 441 or 442, through the user interface unit 240.

In case of Yes, the image search execution unit 230 deletes the added search key image on the key image display area 441 or 442, and ends the key image registration process.

In case of No, the process proceeds to step S307.

At step S307, the image search execution unit 230 determines whether or not the user has instructed to delete the registered key image. Specifically, the user interface unit 240 determines whether or not the user has selected the registered key image with high similarity and has pushed the ‘delete’ button 520.

In case of Yes, the process goes to step S308.

In case of No, the process goes to step S309.

At step S308, the image search execution unit 230 deletes a selected registered image.

Specifically, the image search execution unit 230 deletes from the image search data storage unit 220 a registered key image, selected by the user, on the key image display area 441 or 442.

At step S309, the image search execution unit 230 checks whether or not the user intends to conserve the currently added search key image. Specifically, the image search execution unit 230 determines whether or not there is a push on the ‘conserve’ button 530 on the key image display area 441, 442, or 443, through the user interface unit 240.

In case of Yes, the process goes to step S310.

In case of No, the process returns to step S306 and the image search execution unit 230 allows the user to select the conservation or deletion of the added search key image or the deletion of the registered key image and to decide the key images to be registered.

At step S310, the image search execution unit 230 registers an added search key image.

Specifically, the image search execution unit 230 stores, in the image search data storage unit 220, the added search key image displayed on the key image display area 441, 442, or 443.

From the above, the key image registration process ends which identifies and displays, as the deletion candidate images, the preregistered key images, having a similarity to the newly added key image and the magnitude of the similarity being greater than the threshold value, and deletes a corresponding preregistered key image. Thereafter, the process goes to step S103 shown in FIG. 2.

Referring back to FIG. 2, at step S111, the image search execution unit 230 executes a key image updating process using a preregistered key image with the highest similarity to the newly added key image.

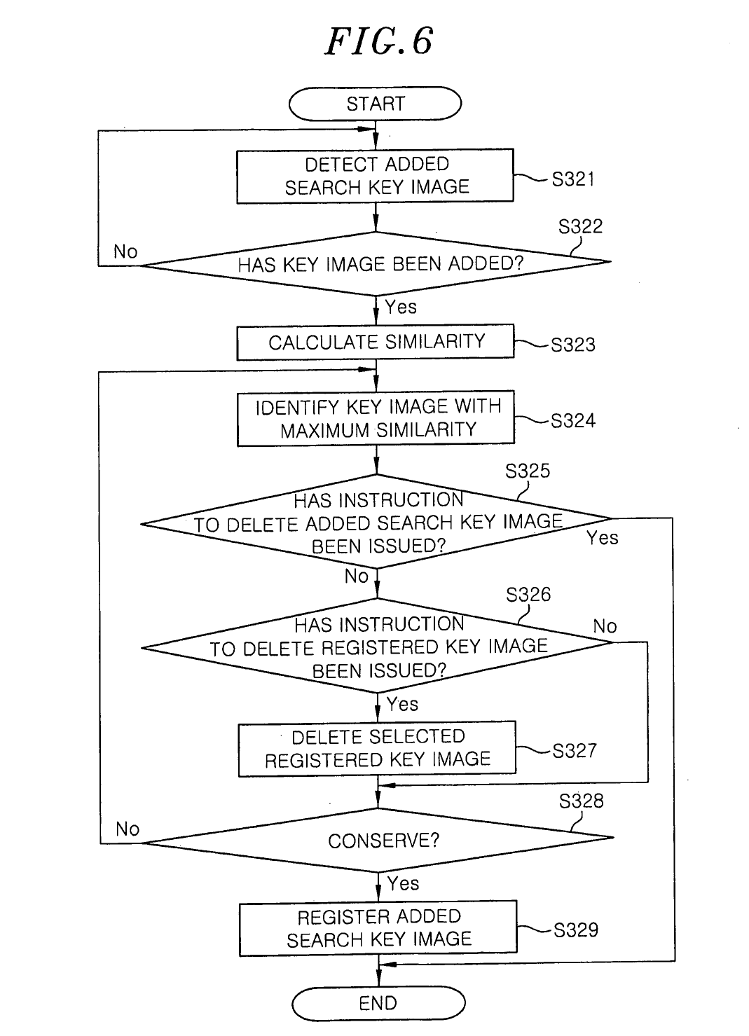

Hereinafter, this process will be described in detail with reference to a flowchart of FIG. 6.

The key image updating process using a preregistered key image with the highest similarity is an example of a key image registration process that identifies and displays, as the deletion candidate image, the preregistered key image having the highest similarity to the newly added key image.

In this process, as described above, the single image with the highest similarity can be selected as the registered key image of the deletion candidate.

First, the image search execution unit 230 executes steps S321, S322, and S323 in the same manners as steps S301, S302, and S303 shown in FIG. 5, respectively.

At step S324, the image search execution unit 230 executes a process of identifying a key image with the highest similarity.

Specifically, the registered key image, with the highest similarity calculated at step S323, i.e., of a frame having a registration ID of i with the smallest distance Zᵢ of the image feature is selected and displayed on the display unit.

With reference to FIG. 8, the key image updating process using a preregistered key image with the highest similarity will now be described in more detail.

The key image display area 444 of FIG. 8 is shown by selecting ‘key image having the highest similarity’ in the display setup area 600 shown in FIG. 9.

The key image display area 444 of FIG. 8 shows an example in which the key image candidates to be registered are displayed by the key image updating process using a preregistered key image with the highest similarity.

That is, the image search execution unit 230 displays, on the key image display area 444, the added search key image and another one, i.e., the registered key image with the highest similarity, through the use of the user interface unit 240. At this time, as shown in FIG. 8, other key images than those with the highest similarities may also be displayed.

On the key image display area 444, an instruction to delete or conserve a newly added key image and to delete the registered key image with the highest similarity can also be issued by the ‘delete’ button 520 or the ‘conserve’ button 530.

Thereafter, the image search execution unit 230 executes steps S325, S326, S327, S328 and S329 in the same manners as steps S306, S307, S308 and S310 in FIG. 5, respectively.

Further, upon determination of No at step S328, the process returns to step S324 to also search the key image with the highest similarity.

From the above, the key image updating process using a preregistered key image with the highest similarity is completed, which identifies and displays the preregistered key image having the highest similarity to the newly added key image as the deletion candidate image.

Next, the process proceeds to step S103 shown in FIG. 2.

Referring again to FIG. 2, the flow of the specific target search process will now be described in detail.

At step S103, the user interface unit 240 detects whether the search process is started up or not.

That is, the user interface unit 240 detects, using API (Application Programming Interface) of OS, whether or not the user has issued a search instruction through the keyboard or the pointing device. Specifically, upon the ‘execute’ button 500 on the search range input area 410 of FIG. 4 being pressed, the user interface unit 240 detects that the search instruction has been issued.

In other cases, the user interface unit 240 executes the processes, such as the registration of key images and/or input of search conditions, according to an instruction of the user.

At step S104, it is determined as Yes by the image search execution unit 230 when the user interface unit 240 detects that the search instruction has been issued. If otherwise, it is determined as No.

In case of Yes, the process goes to step S105 and the image search execution unit 230 executes a detailed process of searching an image similar to the registered key image.

In case of No, the process returns to step S103 and the image search execution unit 230 waits until the user issues the search instruction.

At step S105, the image search execution unit 230 executes a single key image search process.

In this process, the image search execution unit 230 first searches a similar image by using one of the key images on the key image display area 440.

Specifically, as in the similarity calculation process of step S303, a distance Zᵢ of the image feature between a registered key image of a frame having a registration ID of i and an image of a frame within the search range is searched.

Thus, the image search execution unit 230 obtains the image of a frame with high similarity above the predetermined threshold value.

Next, at step S106, the image search execution unit 230 executes a search result conservation process.

Specifically, the image search execution unit 230 stores, in the image search data storage unit 220, a similarity used in search and an image registration ID of a frame with high similarity, as the search results.

Next, at step S107, the image search execution unit 230 determines whether or not the search of all the key images has been completed.

In case of Yes, the process goes to step S108.

In case of No, the process returns to step S105 and image search execution unit 230 executes the same process by using another one of the registered key images. Hereinafter, in the same manner, the image search execution unit 230 searches the similar images from all the registered key images on the key image display area 440 and conserves the search result.

At step S108, the image search execution unit 230 executes a search result response process.

Specifically, the image search execution unit 230 responds with the search results stored in the image search data storage unit 220 to the user interface unit 240, after completing the search of the similar images with respect to all the key images.

The user interface unit 240 displays the image data of the search results by arranging them in the order of their similarities, such that the most similar image among the images searched by the multiple key images is displayed on top. That is, each of the images searched by the multiple search key images has a similarity to its corresponding search key image and the detected images are displayed in the descending order of their magnitudes in similarity. Therefore, when one full face key image is used alone in search and a side face image is included in the search result such side face image is most likely placed at a lower rank in the search result. However, if a full and a side face key image is used in search and a side face image having high similarity to the side face key image is included in the search result, the side face image are displayed with a high rank. If a full face image included in the search result has a high similarity to the full face key image, the full face image is also displayed with a high rank.

Further, the rearrangement of images in the order of similarity by the user interface unit 240 can be achieved by using a method that lists them in the order of similarity for each key image.

With reference to FIGS. 9A and 9B, the rearrangement display of the search results will now be described.

The search result display area 431 in FIG. 10A presents an example which lists and displays all the search results in the order of similarity.

The search result display area 432 in FIG. 10B shows an example which lists and displays the search results in the order of similarity for each key image used. The most front side shows the image with the highest similarity, while the images with lower similarities are shown at more rear side. Also, it may be configured such that as the number of the images with high similarities obtained by search gets larger, those images are getting displayed at farther on the left.

Further, the user interface unit 240 may be configured to switch and display these two display areas depending on the user's needs.

From the above, the specific target search process is completed.

<Automatic Search Process>

The above specific target search process has been described with respect to an example in which the image search is executed from the stored image data in response to a user's instruction to search images.

In this regard, for prior prevention of events, it is regarded that the trend of a specific target can be found out by executing multiple searches daily or weekly. However, it is inefficient to execute such searches by a person daily or hourly. To this end, it is preferable that the image search apparatus 203 performs an automatic search in a state where a search condition and search time are previously set, and confirms the search results later.

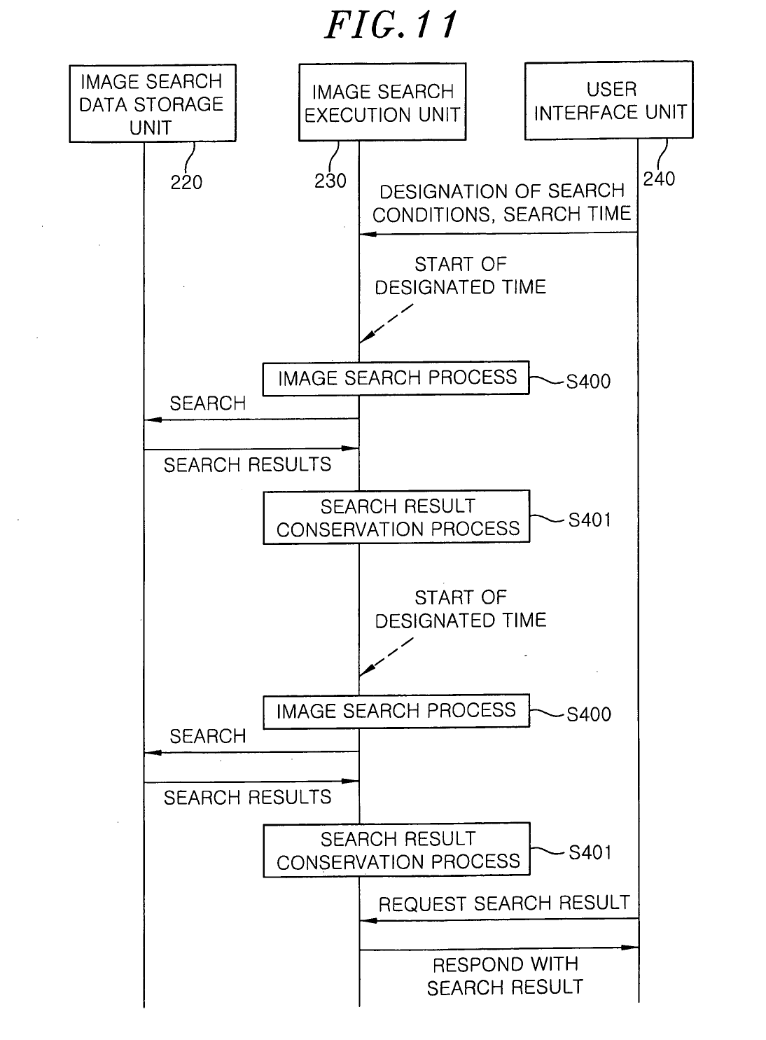

Hereinafter, the automatic search process that executes the automatic search based on a preset search condition and search time will be described with reference to a sequence diagram shown in FIG. 11.

First, the user interface unit 240 executes the image feature detection process, the key image registration process and the setting of a search condition, as in the specific target search process shown in FIG. 2 described above.

In addition, the user interface unit 240 sets time information including a search time to execute searching. The set time information is stored in the storage unit by the image search execution unit 230.

Upon arrival of the set search time, the image search execution unit 230 is started up by the service such as a task manager or by a daemon such as cron.

The started image search execution unit 230 executes an image search process at step S400. This image search process executes searching by using multiple key images, as in steps S105 to S107 in FIG. 2.

Next, at step S401, the image search execution unit 230 executes a search result conservation process.

Specifically, the image search execution unit 230 stores the image data and/or similarities as the search results in the image search data storage unit 220.

If there are multiple set search times, the image search execution unit 230 is stared up at a given time and repeatedly executes the image search process and the search result conservation process.

In addition, upon detection of any input from the user, the user interface unit 240 requests the image search execution unit 230 for the search results.

The image search execution unit 230 responds with the conserved search results to the user interface unit 240.

This search results response is executed as in the search result response process of step S108 in FIG. 2.

Also, in this automatic search process, multiple search result images may be listed and displayed in time series.

From the above, the automatic search process is completed.

With the above-described configuration, the following effects can be obtained.

First, as in the above-described Japanese patent document, the conventional image search using the image feature aiming at a person search tends to have a search result such that, when a full face of a person is used as a key image, full faces occupy a high rank in the search result while an oblique face of the same person is at a low rank thereof. On the contrary, for an oblique face used as a key image, oblique faces tend to occupy a high rank in the search result. That is, there has been a problem in that images included in the high rank in the search result vary depending on the selection of a key image.

In this regard, the image search apparatus 203 of the surveillance system X in accordance with the embodiment of the present invention provides an interface that can easily perform multiple searches by using key images with different pick-up angles. In this manner, more images having a search target person can be obtained by performing multiple searches by using the key images with different pick-up angles. In this case, a wide image feature space can be efficiently searched by repeatedly performing searches by using, as a new key image, an additional image that is regarded as having low similarity with the previously used key image. This method of executing multiple searches while user changing the key image is advantageous in searching a specific target after occurrence of an event.

Further, for prior prevention of events, the trend of a specific target can be recognized by executing multiple searches in the daily or weekly automatic search process. That is, an automatic search can be executed with a search condition and search time set in advance and the search results can be confirmed later. Thus, this method can improve efficiency compared to a method of executing image searching by a person daily or hourly.

In this way, the image search apparatus 203 in accordance with the embodiment of the present invention can provide the user interface unit 240 with high efficiency and convenience in the image search using the image features of a person and/or object in the video surveillance system.

Specifically, by allowing multiple key images of image search targets to be registered as the search condition, the loss of search caused by the difference between directions of the search target and/or pick-up angles can be reduced. Thus, the image search can be efficiently executed.

In addition, whenever a key image is added to the search condition, the candidate images to be deleted from the search condition can be displayed and deleted by the user. Thus, redundant or long image search processing can be suppressed and high speed image search can be realized.

Also, an input search condition can be stored and used to execute an automatic search. Thus, the system having the effect of prior prevention of events is provided.

Further, the user interface unit 240 of the image search apparatus 203 in accordance with the embodiment of the present invention is characterized by displaying multiple images as the search condition and displaying the candidate images to be deleted from the search condition whenever an image is added as the search condition.

Furthermore, the user interface unit 240 of the image search apparatus 203 in accordance with the embodiment of the present invention is characterized by classifying and displaying multiple images as the search condition into similar groups.

Additionally, the image search apparatus 203 in accordance with the embodiment of the present invention is characterized by including the image search data storage unit (storage means) 220 that stores the input search condition, executing searching at a predetermined time by using the stored search condition, and allowing the user interface unit 240 to display the search results upon request of the user.

Also, this embodiment is not limited to execute searching by using multiple images as the key image, but may execute searching by using, for example, a representative image of each similar image group.

Further, each unit of the image search apparatus 203 in this embodiment may not be realized by each separate hardware, and multiple units may be realized by one hardware. For example, the image feature extraction unit 210, the image search data storage unit 220, and the image search execution unit 230 may be realized by a computer such as PC. Also, the user interface unit 240 may be realized by another computer such as PC and the image search apparatus 203 may be implemented by coupling the respective computers via the network.

In addition, the surveillance system X in accordance with the embodiment of the present invention illustrates a person as a search target, but the present invention may also be applied to the general image search, in addition to the person.

Moreover, the configuration and operation of this embodiment are illustrated only by way of example, but it will be understood that appropriate changes or modifications can be made without departing from the spirit and scope of the invention.

In short, in accordance with the present invention, by registering multiple images as the search condition, the loss of search caused by a difference between directions of search target and/or pick-up angles can be reduced, and the image search apparatus which can obtain more images having a search target person and has high search efficiency can be provided.

While the invention has been shown and described with respect to the embodiments, it will be understood by those skilled in the art that various changes and modification may be made without departing from the scope of the invention as defined in the following claims.

What is claimed is:

1. An image search apparatus, comprising:
an image feature extraction unit for extracting features of images;
an image search data storage unit for storing the features of the images;
a user interface unit for inputting an image search condition, and displaying a search result; and
an image search execution unit for executing an image search, by using the features of the images based on the image search condition,
wherein the user interface unit allows multiple key images to be inputted as the single search condition, the image search execution unit executes the search by using key images included in the single search condition, and the user interface unit displays the search result in the order of similarities to the key images.

2. The image search apparatus of claim 1, wherein the user interface unit displays the key images employed as the search condition, and displays candidate images to be deleted from the search condition whenever an additional key image is added to the search condition.
